(19) United States
(12) Patent Application Publication
(10) Pub. No.: US 2018/0106315 A1
(43) Pub. Date: Apr. 19, 2018

(54) PARKING BRAKE TORQUE LOCKING MECHANISM

(71) Applicant: AKEBONO BRAKE INDUSTRY CO., LTD, Tokyo (JP)

(72) Inventors: Galus Chelaidite, South Lyon, MI (US); Waleed Al-Mahshi, Farmington Hills, MI (US); Carla Thomas, Royal Oak, MI (US)

(21) Appl. No.: 15/785,661

(22) Filed: Oct. 17, 2017

Related U.S. Application Data
(60) Provisional application No. 62/408,904, filed on Oct. 17, 2016.

(51) Int. Cl. F16D 65/18

(52) U.S. Cl. CPC F16D 65/18; F16D 2121/24

(57) ABSTRACT

A parking brake system including a motor; a rotary to linear stage mechanism in communication with the motor; and a torque locking mechanism in communication with the motor. The torque locking mechanism includes a rotor; a core; and locking members. During a parking brake apply the motor is adapted to rotate the rotor and move the rotary to linear stage mechanism so that at least one brake pad or at least one brake shoe is moved against a surface to generate a clamp force. After the clamp force is generated and the motor ceases to rotate the rotor, the core and the locking members are magnetically attracted and the locking members move towards the core as a result of the magnetic attraction so that the generated clamp force is maintained after the motor ceases to rotate the rotor.

### FIELD

These teachings relate to preventing a motor from back driving and to maintaining clamp force in a brake system.

### BACKGROUND

A disc brake system includes opposing brake pads that are moved towards one another and into engagement with a brake rotor to create a clamp force to slow or stop a moving vehicle. A drum brake system includes opposing brake shoes that are moved away from one another and into engagement with a brake drum to create a clamp force to slow or stop a moving vehicle.

Both disc brake systems and drum brake systems typically include a parking brake system that functions to move the brake pads or brake shoes, respectively, into engagement with the respective brake rotor or brake drum to create a clamp force to maintain the vehicle in a stopped or parked position.

Some parking brake systems include an electric motor and at least one rotary to linear stage mechanism. In disc brake systems, the motor and the rotary to linear stage cooperate to move the brake pads into engagement with the brake rotor to create the clamp force to maintain the vehicle in a stopped or parked position. In drum brake systems, the motor and the rotary to linear stage mechanism cooperate to move the brake shoes into engagement with the brake drum to create the clamp force to maintain the vehicle in a stopped or parked position.

In some parking brake systems, the rotary to linear stage mechanism is a high efficiency mechanism. Efficiency may refer to how well, or how “efficiently”, the mechanism converts or transfers torque from the motor into a linear load or output force. An example of a high efficiency mechanism is a ball screw. Compared to normal or low efficiency rotary to linear stage mechanisms, such as a typical screw and nut setup, high efficiency rotary to linear stage mechanisms may be used to develop the clamp force faster, while using less torque, and while also reducing packaging space, weight, and/or cost of the system. However, after the clamp force is created and the motor is turned OFF, a high efficiency rotary to linear stage mechanism may undesirably back drive, which may result in an unintended reduction or elimination of the clamp force, which may result in the vehicle moving or rolling away.

To remedy the aforementioned back-driving issue, various “self-locking” features have been proposed. For example, “non-back-drivable” elements, such as worm type reduction gears and/or short pitch drive screws have been contemplated to incorporate friction to maintain the clamp force and prevent back driving. However, overcoming the friction of these self-locking features during application of the parking brake typically requires a larger motor, which undesirably increases packaging space, weight, and/or cost of the system.

It may therefore be desirable to have a locking mechanism that maintains clamp force and prevents back driving of a brake system after electrical power the motor is turned OFF. It may be desirable to have a torque locking mechanism that functions to prevent back driving of one or more rotary to linear stage mechanisms after the motor is turned OFF to prevent the clamp force from being prematurely reduced or eliminated. It may be desirable to have a torque locking mechanism that, during a parking brake apply, provides little friction or torque that must be overcome so that the clamp force can be developed quickly and efficiency, and after the parking brake apply is complete and the motor is turned OFF, provides sufficient friction or torque to maintain the clamp force and prevent back driving of the system.

### SUMMARY

These teachings provide a torque locking mechanism that is adapted to prevent a motor from back driving. The teachings a brake system that includes a torque locking mechanism to maintain developed clamp force to prevent back driving of a motor and premature release of the clamp force.

The torque locking mechanism according to these teachings functions to prevent back driving of one or more rotary to linear stage mechanisms after the motor is turned OFF to prevent the clamp force from being prematurely reduced or eliminated. During a brake apply, the torque locking mechanism functions to provide little friction or torque so that the clamp force can be developed quickly and efficiency, and after the parking brake apply is developed and the motor is turned OFF, provides sufficient friction or torque to maintain the clamp force and prevent back driving of the system.

These teachings may be applicable to brake systems, parking brake systems, or both. That is, the clamp force as discussed herein can be used during application of the service brake, parking brake, or both.

A brake system comprising: a motor; a rotary to linear stage mechanism in communication with the motor; and a torque locking mechanism in communication with the motor. The torque locking mechanism comprising: a rotor; a core; and a plurality of locking members. During a brake apply, the motor is adapted to rotate the rotor and move the rotary to linear stage mechanism so that at least one brake pad or at least one brake shoe is moved against a surface to generate a clamp force. After the clamp force is generated and the motor ceases to rotate the rotor, a magnetic attraction between the core and the locking members moves the locking members towards the core so that the generated clamp force is maintained and prevented from back driving.

A system comprising: a motor comprising a motor output; a rotary to linear stage mechanism in communication with the motor output; and a torque locking mechanism in communication with the motor. The torque locking mechanism comprising: a rotor fixed to the motor output, the rotor comprises a plurality of detents; a core that is fixed and restricted from rotating relative to the rotor; a plurality of ramps surrounding the core; and a plurality of locking members. During a first condition, the motor output is adapted to rotate the rotor and move the rotary to linear stage mechanism to generate a clamp force. After the clamp force is generated and the motor output ceases to rotate the rotor, the core and the locking members are magnetically attracted and the locking members move towards the core until the locking members engage a groove defined between adjacent ramps so that the generated clamp force is maintained and the rotary to linear state mechanism is prevented from back driving. During a second condition, a centrifugal force generated by the motor and the rotating rotor overcomes the magnetic attraction causing the locking members to move to an outer portion of the detents and out of engagement with the grooves.

A system comprising: a motor comprising a motor output; a torque locking mechanism in communication with the motor output. The torque locking mechanism comprising a rotor fixed to the motor output, the rotor comprises a plurality of detents; a core that is fixed and restricted from rotating relative to the rotor; a plurality of ramps surrounding the core; and a plurality of locking members located in the detents. The motor output is adapted to generate torque, and after the torque is generated, the torque locking mechanism is adapted to maintain or prevent back driving of the motor output.

### BRIEF DESCRIPTION OF THE DRAWINGS

FIG. 1 is a perspective view of a brake system that is a disc brake system.

FIG. 2 is a perspective, cross-sectional view of a brake piston and a rotary to linear stage mechanism of the disc brake system of FIG. 1.

FIG. 3 is a perspective view of a brake system that is a drum brake system.

FIG. 4 is a perspective, side view of a motor and a torque locking mechanism.

FIG. 5 is a perspective, cross-sectional view of a torque locking mechanism.

FIG. 6 is an exploded, perspective view of the torque locking mechanism of FIG. 5.

FIG. 7 is a partial, cross sectional view of the ramps of the torque locking mechanism of FIGS. 5, 6, and 8.

FIG. 8 is a partial, front, cross-sectional view of the torque locking mechanism of FIGS. 5 and 6.

FIG. 9 is a perspective, cross-sectional view of a torque locking mechanism.

FIG. 10 is an exploded, perspective view of the torque locking mechanism of FIG. 9.

FIG. 11 is a partial, front, cross-sectional view of the torque locking mechanism of FIGS. 9 and 10.

FIG. 12 is a perspective, cross sectional view of a torque locking mechanism.

FIG. 13 is a perspective, cross sectional view of the torque locking mechanism of FIG. 12.

FIG. 14 is an exploded, perspective view of the torque locking mechanism of FIGS. 12 and 13.

FIG. 15 is a partial, cross sectional view of the ramps of the torque locking mechanism of FIGS. 12-14.

FIG. 16 illustrates the torque locking mechanism of FIGS. 12-14 in an unlocked or disengaged configuration.

FIG. 17 illustrates the torque locking mechanism of FIGS. 12-14 in a locked or engaged configuration.

FIG. 18 is a perspective, exploded view of a torque locking mechanism.

FIG. 19 is a perspective, cross sectional view of the torque locking mechanism of FIG. 18.

FIG. 20 is a partial, cross sectional view of the ramps of the torque locking mechanism of FIGS. 18-1.9.

### DETAILED DESCRIPTION

This application claims the benefit of U.S. 62/408,904 filed on Oct. 17, 2016, the entire disclosure of which is hereby incorporated by reference herein for all purposes.

The teachings herein provide a brake system. The brake system may be any system or assembly for creating a clamping force. The brake system may function to create a clamping force to slow, stop, and/or maintain a moving component, such as a brake rotor, a brake drum, or a road wheel of a vehicle, in a stopped or parked position. The brake system may function to release the clamping force so that the moving component, such as the brake rotor or brake drum or the road wheel of the vehicle, can move. The brake system may be used as a service brake, a parking brake, or both.

The brake system may be any type of brake system. For example, the brake system may be an opposing brake system (i.e., a fixed caliper brake system) or a floating brake system (i.e., a floating caliper). The brake system may be a drum brake system. The brake system may be a service brake system.

A parking brake system may be added to or integrated with or operable with the brake system. The parking brake system may function to create a clamp force to maintain a moving component, like a brake rotor, a brake drum, or a road wheel of a vehicle, in a stopped or parked position. The parking brake system may be used as a service brake, a parking brake, or both.

The parking brake system may utilize one or more components of the brake system to create the clamp force. For example, during a parking brake apply, the parking brake system may be adapted to move one or more brake pistons and brake pads against a brake rotor to create the clamp force. The parking brake system may be adapted to move the one or more brake pistons and brake pads away from the brake rotor to release the clamp force. For example, during a parking brake apply, the parking brake system may be adapted to move an expander mechanism, which may thus move one or more brake shoes against the brake drum to create the clamp force or away from the brake drum to release the clamp force.

The brake system, the parking brake system, or both may be used in vehicular applications to slow, stop, and/or prevent movement of a road wheel.

Additionally, or alternatively, the brake system, the parking brake system, or both may find use in non-vehicular applications to slow, stop, and/or prevent movement of a moving component in applications such as, for example, a lathe, a paper winder, an amusement park ride, and the like.

The clamp force may be any force that, when coupled with a brake pad or brake shoe coefficient of friction, functions to create drag to decelerate, slow, stop, and/or prevent movement or rotation of a moving component, which may be a brake rotor, drum, and/or a road wheel in vehicular applications. The clamp force may be created during a standard brake apply (i.e., a brake apply force). The clamp force may be created during a parking brake apply (i.e., a parking brake force).

The brake system, the parking brake system, or both may comprise a motor gear unit (MGU). The motor gear unit (MGU) may function to create or generate a force or torque, and then transfer the force or torque to move one or more rotary to linear stage mechanisms, brake pistons, expander mechanisms, or a combination thereof to move the brake pistons or brake shoes against a brake rotor or brake drum create and/or release the clamp force.

During release of the brake system or the parking brake system to release the clamp force, the MGU may function to generate torque sufficient to move the one or more rotary to linear stage mechanisms, the one or more brake pistons, the one or more expander mechanisms, or a combination thereof so that the brake pads or brake shoes move away from the brake rotor or brake drum thus releasing the clamp force. During a brake or parking brake apply or release, the MGU may generate torque sufficient to overcome the magnetic attraction between the core and the locking members that are adapted to lock the motor or MGU and prevent a back driving thereof when the motor or MGU is turned OFF.

At least a portion of the MGU may be contained within a housing. The housing may be integrally formed with the brake caliper or the backing plate; removably attached to the brake caliper or the backing plate; permanently attached to the brake caliper or the backing plate; or attached, in any suitable way to any part of a vehicle, such as a support, support bracket, or knuckle. The housing may contain a motor, one or more gears or gear trains, one or more torque locking mechanisms, or a combination thereof. One or more or even all of the components of the MGU, including the motor, one or more gears, one or more components of the torque locking mechanism or a combination thereof may be rigidly connected or attached to the housing to prevent movement of the components. For example, the core, the spacer, the one or more plates, or a combination thereof may be fixed to the housing and restricted or prevented from rotating or otherwise moving relative to the rotor or motor output, while the rotor and motor output are adapted to move or rotate. One or more or even all of the components of the torque locking mechanism may be located externally of the housing of the MGU.

The motor gear unit (MGU) may include one or more gears or gear trains that may function to transfer, amplify, increase, and/or decrease power output from the motor. The one or more gears or gear trains may function to increase or decrease an output speed of a motor, increase or decrease a torque output of a motor, or both. The one or more gears or gear trains may increase or decrease torque output from the motor to the spindle.

The brake system, the parking brake system, the MGU, or a combination thereof may include a motor. The motor may be any suitable motor for creating a force or torque. For example, the motor may be a DC motor, a brushless motor, a series-wound motor, a shunt wound motor, a compound wound motor, a separately exited motor, a servomotor, a stepping motor, or a permanent magnet motor.

The motor may have a motor output and a motor shaft. The motor output and the motor shaft may be connected such that when the motor shaft is locked or engaged by the torque locking mechanism, the motor output is restricted or prevented from rotating. Accordingly, when the motor shaft is unlocked or disengaged by the torque locking mechanism, the motor output can be rotated. The motor shaft may be in communication with the torque locking mechanism and the output shaft may be in communication with the rotary to linear stage mechanism or one or more gears (e.g., gear train) that are in communication with the rotary to linear state mechanism or spindle. Rotation of the motor output functions to move or rotate the spindle of the rotary to linear stage mechanism, or one or more gear trains located between the motor output and the spindle.

The brake system, the parking brake system, the motor, the motor gear unit (MGU), or a combination thereof may include one or more torque locking mechanisms. Alternatively, the torque locking mechanism may be an individual component or assembly that is added to or incorporated into the brake system, the parking brake system, the motor, the MGU, or a combination thereof.

The torque locking mechanism may function to restrict or prevent the motor, the output of the motor, or both from back driving. Back driving may mean rotating or unwinding in an opposite direction. Back driving may mean an unintended or premature rotating or unwinding in an opposite direction. Back driving may result from an opposing reaction force acting on the rotary to linear stage mechanism after clamping force has been developed. Because the rotary to linear stage mechanism is high efficiency or has low friction between the spindle and nut, the opposing reaction force may be sufficient to unwind or back drive the rotary to linear stage mechanism when the motor is turned OFF. This may prematurely or unintentionally release the developed clamp force, which may result in an unintended vehicle roll away.

The torque locking mechanism may function to restrict or prevent the one or more rotary to linear stage mechanisms from back driving. The torque locking mechanism may function to restrict or prevent the brake system, the parking brake system, or both from prematurely releasing the clamp force after the clamp force has been created or generated and after the motor or MGU has been turned OFF. The torque locking mechanism may function to restrict or prevent the high efficiency mechanisms or rotary to linear stage mechanisms from back driving after electrical power to the motor or MGU is turned OFF or ceases to be applied.

The torque locking mechanism is operable in a locked or engaged condition and in an unlocked or disengaged configuration

When the torque locking mechanism is locked or engaged, the torque locking mechanism functions to maintain the clamp force developed by the brake system or the parking brake system. The locked or engaged condition may be when one or more of the locking members or balls are in contact with or are near the core, the groves, or at a radially lower position in the detents of the core thereby wedging themselves the rotor and the stationary core, which therefore restricts or prevent the rotor from rotating by way of the opposing reaction force of the developed clamping force acting on it.

When the torque locking mechanism is unlocked or disengaged, the clamp force developed by the brake system or parking brake system can be released, or is no longer maintained. The unlocked or disengaged condition may be when one or more of the locking members or balls are out of contact with or are away from the core, the groves, or at a radially higher position in the detents of the core thereby, thereby allowing the rotor to rotate.

The torque locking mechanism may be located within the MGU housing; may be attached to the motor (e.g., to the motor shaft or to the motor output); may be attached to a rotary to linear stage mechanism; may be located internally within a motor, may be part of the motor, may be part of the brake system, may be part of the parking brake system, or a combination thereof. The torque locking mechanism may be an independent assembly or mechanism that is added to the motor, the MGU, the brake system, the parking brake system, or a combination thereof. The torque locking mechanism may be located upstream of an output shaft of the motor that is connected to the rotary to linear stage mechanism.

The torque locking mechanism as described herein is operable with the motor or MGU. Therefore, the torque locking mechanism may be used with the motor, but without the brake system, the parking brake system, or both. Stated another way, the torque locking mechanism may find use in other no-vehicular applications, such as a lathe, amusement park rides, a paper winder, or any other suitable application where a motor or MGU is used to move an object, mechanism, or assembly, and a device is required in order to prevent the motor, object, mechanism, or assembly from back driving when the motor ceases to generate torque or is turned OFF.

The torque locking mechanism may include one or more rotors. The rotor may be rigidly attached to a motor shaft or motor output of the motor and may rotate with the motor shaft when the torque locking mechanism is unlocked and disengaged and the motor shaft rotates. The rotor may be rigidly attached to a motor shaft of the motor and may be restricted from axially moving along an end of the shaft. The rotor may be made of plastic or metal. Preferably, however, the rotor is made of a non-magnetic material so that the rotor does not inter with movement of the locking members and the core.

The rotor may include one or more detents. The one or more detents may be adapted to receive and/or house one of the locking members. The one or more detents may be located or defined in an inner diameter of the rotor. The detents may function to allow the locking members or balls to move between an engaged or locked position and a disengaged or unlocked position.

In the locked or engaged position, the locking members or balls are moved radially inwards or downward in the detents by way of a magnetic attraction with the core. In the unlocked or disengaged position, the locking members or balls are radially outwards or upward to an upper portion of the detents by way of centrifugal force resulting from the rotor rotating by the motor or MGU.

The torque locking mechanism may include one or more cores. The core may be fixed and restricted or prevented from moving or rotating. That is, the core may be fixed, restricted, or prevented from moving relative to the rotor, the motor output, or both while the rotor and the motor output rotate. For example, the core may be fixed to a housing or other non-moving part of the brake system, the parking brake system, the MGU, the motor, or a combination thereof.

The core may be a magnet. The core may be a permanent magnet. The core may be made from a material that is attracted to a magnet, such as iron, nickel, and cobalt, for example. The core may have a smooth surface. The core may have a surface that includes one or more grooves, ramps, inclined portions (i.e., feature of the spacer described below). The core and the one or more locking members may be magnetically attracted to one another to lock or engage the torque locking mechanism. The magnetic attraction between the locking members and the core may be less than a centrifugal force acting on the rotor when the motor output is rotated by the motor.

The torque locking mechanism may include one or more locking members. The locking members may function to lock the torque locking mechanism and restrict or prevent the motor, the rotary to linear stage mechanism, or both from rotating or back driving. The locking members may function to unlock the torque locking mechanism so that the motor, motor output, the rotary to linear stage mechanism, or both are free to move.

The locking members may be magnets. The locking members may be permanent magnets. The locking members may be made from a material that is attracted to a magnet, such as iron, nickel, and cobalt, for example. The locking members may have any shape, such as a cylindrical or spherical shape. The locking members may be balls or ball bearings.

The locking members may be radially moveable relative to a core. The locking members may be radially moveable inwards or downwards towards the core to lock or engage the torque locking mechanism. The locking members may be radially moveable towards the core when the magnetic attraction between the locking members and the core is greater than any other force acting on the locking members.

The locking members may be radially moveable away or upwards or outwards from the core to unlock or disengage the torque locking mechanism. The locking members may be radially moveable away from the core when the magnetic attraction between the locking members and the core is less than other forces acting on the locking members, like a centrifugal force acting on the locking members when the motor output and rotor rotates by the motor.

The torque locking mechanism may include one or more plates. The plates may function to lock or retain the locking members when the torque locking mechanism is locked or engaged. One or more plates may be fixed to the core, made integral with the core, sandwich the core, surround the core, or a combination thereof. The plates may be fixed and restricted or prevented from moving or rotating. Alternatively, the plates may move or rotate. The plates may be a magnet. The plates may be a permanent magnet. The plates may be made from a material that is attracted to a magnet, such as iron, nickel, and cobalt, for example. The plates may have one or more ramps, grooves, or detents for receiving a locking member or ball to lock or engage the torque locking mechanism.

The torque locking mechanism may include one or more spacers. The spacer may function to lock or retain the locking members when the torque locking mechanism is locked or engaged. The spacer may be fixed to the core, made integral with the core, sandwich the core, surround the core or a combination thereof. The spacer may be fixed and restricted or prevented from moving or rotating. Alternatively, the spacer may move or rotate. The spacer may be a magnet. The spacer may be a permanent magnet. The spacer may be made from a material that is attracted to a magnet, such as iron, nickel, and cobalt, for example. The spacer may be made from a non-magnetic material such as plastic. The spacer may have one or more ramps, grooves, or detents for receiving a locking member to lock or engage the torque locking mechanism. One or more of the features of the spacer may be made integral or incorporated into an outer surface of the core. The core may include an inner diameter, into which the core may be located or received.

The torque locking mechanism may include one or more ramps or grooves. The one or more ramps or grooves may function to lock, retain, and/or maintain a locking member to lock or engage the torque locking member. The one or more ramps or grooves may be located on one or more plates, cores, spacers, or a combination thereof. The ramps or grooves may have an inclined portion that may function to allow a locking member to move up with low motor load or torque during a re-clamp when the rotor, the motor, or both is rotated in an apply direction. The one or more ramps, grooves, or detents may have an edge that may function to restrict or prevent a locking member from moving or disengaging tfie one or more ramps, grooves, or detents when the rotor, the motor, or both is rotated in a release direction so that release of the clamp force can be restricted or prevented.

The brake system, the parking brake system, or both may comprise one or more rotary to linear stage mechanisms. The one or more rotary to linear stage mechanisms may function to receive a rotary force or torque form the motor and/or MGU, and then transfer the rotary force or torque into an axial or linear force. The rotary to linear stage mechanism may be adapted to move one or more brake pistons or expander mechanisms to create or release the clamp force.

The rotary to linear stage mechanism may be an actuator or a linear actuator. The rotary to linear stage mechanism may be an expander mechanism. The rotary to linear stage mechanism may include a spindle and a nut. The rotary to linear stage mechanism may include one or more ball screws, roller screws, ball ramps, or a combination thereof. Exemplary ball screws may utilize ball bearings as load transfer elements between the nut and spindle or screw. During movement of the ball screw, the ball bearings may circulate along races or grooves between the spindle and the nut. A roller screw or planetary screw may be similar to a ball screw except that roller screws use rollers as the load transfer elements between nut and screw. The load on a ball screw, the roller screw, or both is distributed over a large number of ball bearings or rollers, via roller threads, respectively, so that each ball bearing or roller, when subjected to force, may roll, and therefore, friction is reduced, which may equate to high efficiency. Accordingly, less force or torque may be required to move a spindle and nut in a ball screw or roller screw in an apply direction, a release direction, or both. A ball ramp may include a rotating side and a stationary side with rolling elements interposed there between. A torque input causes the rotating side to rotate, which also causes the rolling elements to engage and move along ramps between the rotating side and stationary side. The ramps include a deep end and a shallow end. When the rotating side is rotated such that the rolling elements move to the shallow side of the ramp, the rolling elements provide an axial force against the stationary side, thus axially moving the stationary side.

The one or more rotary to linear stage mechanisms may be may be one or more high efficiency devices, one or more low efficiency devices, or both. However, preferably, all of the rotary to linear stages are high efficiency devices. A high efficiency device is a device that is more efficient than a low efficiency device. Efficiency may refer to how well, or how “efficiently” the device converts or transfers torque or a rotational load input form a motor or MGU into a linear load, or output force. Depending on one or more considerations, such as lead angle and coefficient of friction, the one or more high efficiency devices may have an efficiency on the order of approximately 60% or more, approximately 70% or more, approximately 80% or more, approximately 85% or more, approximately 90% or more, approximately 95% or more, 97% or more, or even 99% or more. One or more rotary to linear stage mechanisms may correspond to each piston or expander mechanism. A high efficiency rotary to linear stage mechanism may be a ball screws, roller screws, ball ramps, or a combination thereof.

The one or more rotary to linear stage mechanisms may be non-locking. In other words, because the coefficient of friction between the components in a high efficiency device is generally low, back driving may occur when a reaction force applied to the mechanism (for example to the spindle, the nut, or both) is greater than the static force or coefficient of friction of the high efficiency device. This may undesirably cause the mechanism to rotate or move in an opposing direction after a clamping force has been created. The torque locking mechanism according to the teachings herein may prevent back driving and thus sustain the linear output force and/or maintain the clamp force of the parking brake system. Without such a torque locking feature, the high efficiency devices may undesirably, and prematurely, release the clamp force after the MGU is turned OFF, which may cause a vehicle to unintentionally move.

The brake system, the parking brake system, the motor, or a combination thereof may include one or more controllers. The controller may function to turn the motor or MGU ON and OFF by sending electrical power, voltage, or current to the motor. The controller may function to turn the electromagnet ON and OFF by sending electrical power, voltage, or current to the motor so that the electromagnet generates or ceases to generate a magnetic field, respectively. Turning ON the motor may also result in simultaneously turning ON the electromagnet. Turning OFF the motor may also result in simultaneously turning OFF the electromagnet. Turning ON and OFF the motor may be independent of turning the electromagnet ON and OFF.

The controller may function to monitor the clamp force as it is being created, and may function to turn OFF the motor and/or the electromagnet (e.g., stop or cease ending power thereto) after a suitable clamp force has been created and/or detected. When the controller receives a signal to release the parking brake, the controller may function to to turn ON the motor and/or the electromagnet to generate power to release the clamp force. The signal to the controller may be provided by a suitable means, such as pushing a button, pulling a lever or cable. The signal may be provided automatically when a vehicle is placed in a parking gear, for example. The controller may be in communication with the parking brake system, the motor, the motor gear unit, or a combination thereof to control one or more functions thereof. The controller may communicate with the parking brake system, the motor, the motor gear unit, the electromagnet, or a combination thereof by wire or wirelessly. The controller may include an electronic circuit to provide and/or a voltage polarity of the electromagnet and/or motor. For example, one polarity may be adapted to rotate an output of the motor in an apply direction, and the opposing polarity may be adapted to rotate the output of the motor in a release direction. The controller may include a voltage regulator to maintain a voltage polarity of the electromagnet.

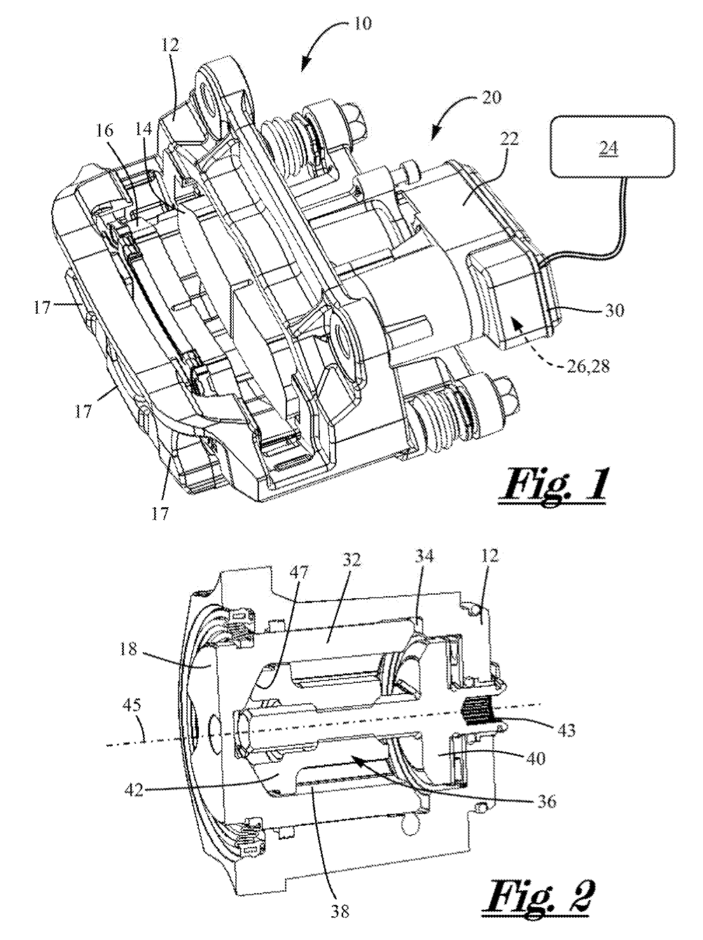

FIG. 1 illustrates a brake system 10. The brake system 10 includes a brake caliper 12 supporting an inboard brake pad 14 and an outboard brake pad 16. The brake pads 14, 16 are arranged such that the friction material of each brake pad 14, 16 faces a side of a brake rotor. The brake caliper 12 includes fingers 17 that are in contact with the outboard brake pad 16.

The brake system 10 includes a parking brake system 20. The parking brake system 20 includes a motor gear unit (MGU) 22 and a controller 24. The MGU 22 includes a motor 26 and a torque locking mechanism 28, both of which are located in a housing 30.

FIG. 2 illustrates a brake piston 32 located in a caliper bore 34 defined in the brake caliper 12. The brake piston 32 includes a face 18 that is adapted to contact the pressure plate of the inboard brake pad 14 during a brake apply and a parking brake apply. A rotary to linear stage mechanism 36 is at least partially located in a piston bore 38 defined in the brake piston 32. The rotary to linear stage mechanism 36 comprises a spindle 40 and a nut 42 that are threadably engaged.

During a brake apply, the motor or MGU 22 is adapted to generate torque, which is transferred or supplied to the input portion 43 of the spindle 40, which causes the spindle 40 to rotate about a longitudinal axis 45 of the spindle 40. The nut 42 is restricted or prevented from rotating about the longitudinal axis 45. Therefore, rotation of the spindle 40 about the longitudinal axis 45 causes the nut 42 to translate axially along the axis 45 in a direction either towards or away from the inboard brake pad 14, depending on the direction that the spindle 40 is rotated.

During the brake apply, the nut 42 is moved in a direction towards a bottom pocket wall 47 defined in the piston bore 38. After the nut 42 contacts the bottom pocket wall 47, further movement of the nut 42 causes the nut 42 to push the brake piston 32 against the inboard brake pad 14, and then push the inboard brake pad 14 into contact with the brake rotor to generate the clamp force (FIG. 1). An opposing reaction force causes the fingers 17 of the brake caliper 12 to move or pull the outboard brake pad 16 into contact with the opposing side of the brake rotor to generate the clamp force (FIG. 1). After the clamping force is created, the torque locking mechanism 28 discussed further below functions to maintain the clamping force and prevent a back driving of the motor or MGU 22 after the motor or MGU is turned OFF.

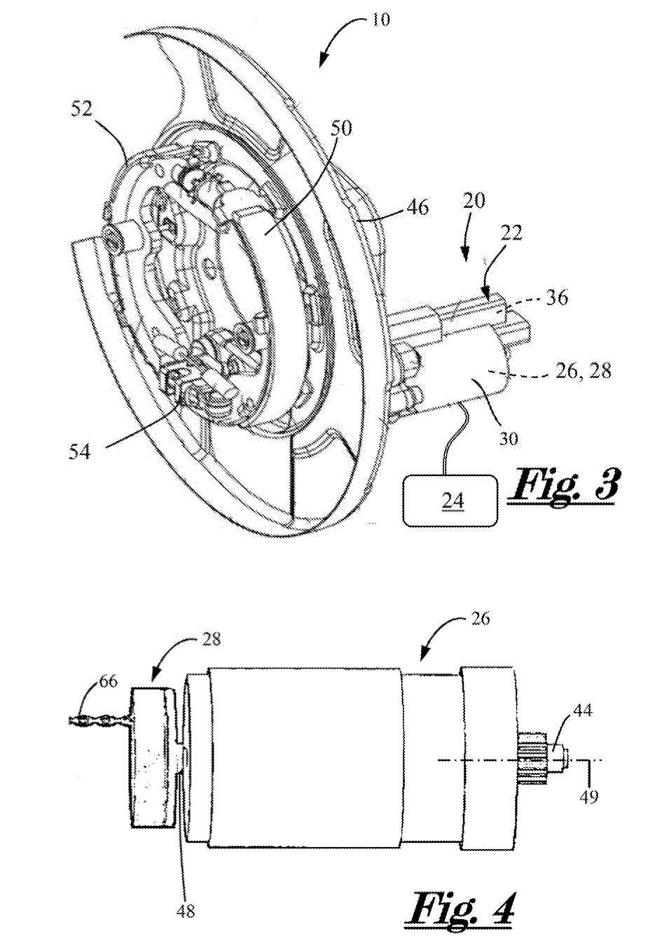

FIG. 3 illustrates a brake system 10. The brake system 10 includes a backing plate 46 that is adapted to support a pair of brake shoes 50, 52. The brake shoes 50, 52 are arranged such that the friction material of each brake shoe 50, 52 faces an inner portion of a brake drum.

The brake system 10 includes a parking brake system 20. The parking brake system 20 includes a motor gear unit (MGU) 22, a controller 24, and a rotary to linear stage mechanism 36. The MGU 22 includes a motor 26 and a torque locking mechanism 28, both of which are located in a housing 30. The rotary to linear stage mechanism 36 is in communication with an expander mechanism 54 of the brake system 10.

During a brake apply, the motor or MGU 22 functions to generate torque. The torque is converted into a linear force by way of the rotary to linear stage mechanism 36. The linear force functions to actuate the expander mechanism 54, which functions to move the brake shoes 50, 52 outwardly away from one another and into contact with brake drum to create the clamping force. After the clamping force is created, the torque locking mechanism 28 discussed further below functions to maintain the clamping force and prevent a back driving of the motor or MGU 22 after the motor or MGU is turned OFF.

FIG. 4 illustrates a motor 26 and a torque locking mechanism 28 for use with the brake system 10 of FIG. 1 and/or FIG. 3. The motor 26 includes an output shaft 44 in communication with one or more gears (e.g., a gear train) or one or more rotary to linear stage mechanisms 36 (of the brake system of FIG. 1 or 3, for example). The output shaft 44 is adapted to rotate about an axis 49 of the output shaft 44. The motor includes a motor shaft 48 in communication with the torque locking mechanism 28. The torque locking mechanism 28 is electrically connected to a power source or controller 24 (FIG. 3) via an electrical connection 66.

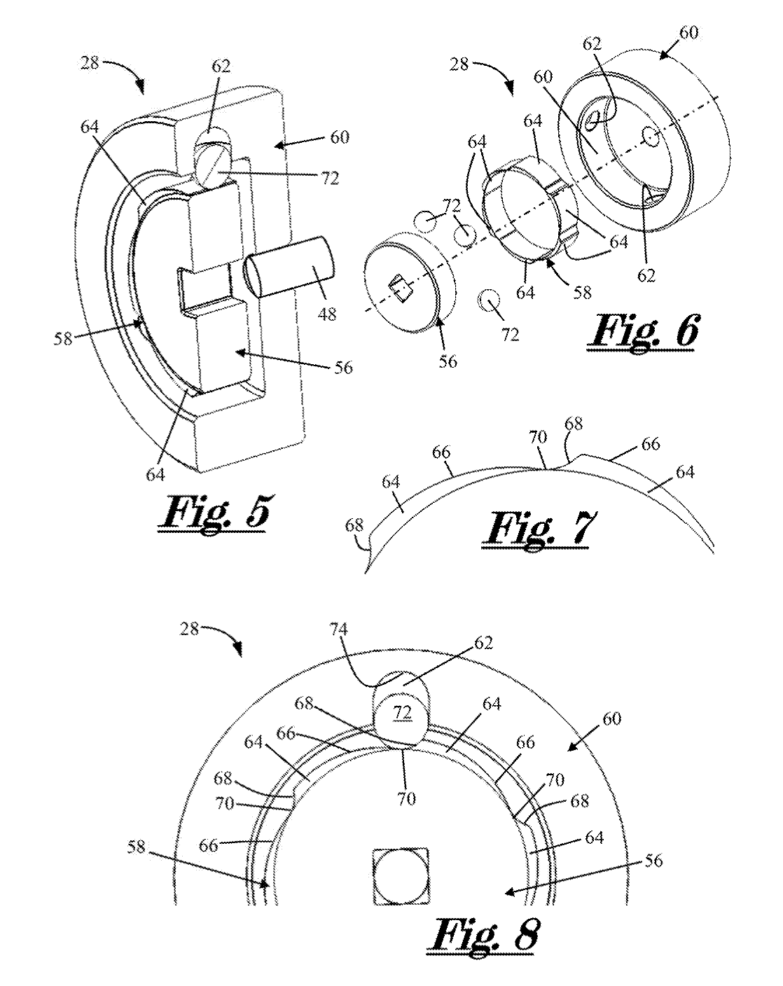

FIGS. 5-8 illustrate a torque locking mechanism 28. The torque locking mechanism 28 comprises a core 56; a spacer 58; and a rotor 60.

The core 56 is fixed, and therefore does not rotate with the motor shaft 48 or rotor 60. The spacer 58 is also fixed and does not rotate with the motor shaft 48 or rotor 60. The spacer 58 is fixed or attached to the core 56. The rotor 60 is fixed to the motor output 48 of the motor 26 and rotates therewith when the motor 26 or MGU is ON.

The rotor 60 comprises a plurality of detents 62 or notches disposed around an inner circumference or diameter 61 thereof. The detents 62 may be equally spaced around the inner circumference or diameter 61 thereof or may be randomly spaced there around. One locking member 72 is received in each detent 62.

The spacer 58 includes a plurality of ramps 64 disposed around an outer circumference or diameter thereof. Each ramp 64 comprises an inclined portion 66; an edge 68; and a groove 70 defined between adjacent incline portions 66 and edges 68.

Locking members 72 are located between the spacer 58 and the rotor 60, and are contained in the detents 62. The locking members 72 are adapted to move between an upper position (i.e., an unlocked position) where the locking members 72 are near or contact an upper edge or portion 74 of the detent 62, and a lower position (i.e., a locked position) where the locking members 72 are near, or in contact with, or located in the groove 70 defined in the spacer 58 (FIG. 8). The locking members 72 are moved into the locked or lower position by way of magnetic force or attraction with the core 56 and/or spacer 58. The locking members 72 are moved into the unlocked or upper position by way of a force overcoming the magnetic force or attraction with the core 56 and/or spacer 58, such as a centrifugal force that is generated when the motor shaft 48 and rotor 60 rotated, as will be discussed further below.

A magnetic attraction exists between the core 56 and the locking members 72. For example, either the locking members 72 are magnets and the core 56 is magnetically attracted to the locking members 72, or the core 56 is a magnet and the locking members 72 are magnetically attracted to the core 56. The magnetic attraction functions to pull or move the locking members 72 into the lower or locked position so that the locking members 72 are near, or in contact with, or located in the groove 70 defined in the spacer 58.

Referring to FIGS. 1-8, before the brake system or the parking brake system is actuated (i.e., during a free running condition of the vehicle; when the motor 26 or MGU is OFF; and/or when electrical power is not being supplied to the motor 26 or MGU), the torque locking mechanism 28 is locked or engaged. This means that the magnetic attraction between the locking members 72 and the core 56 is sufficient to pull or attract the locking members 72 into the lower or locked position where the locking members 72 are located at, near, or inside the grooves 70 defined in the spacer 58. Again, the spacer 58 is rotatably fixed to the core 56 and neither the spacer 58 nor the core 56 rotate relative to the motor shaft 48 and/or rotor 60. Accordingly, in this locked position, because the core 56 is fixed and does not rotate, the rotor 60 and the motor shaft 48 are prevented from rotating or back driving due to the locking members 72 being located or locked or wedged between the moveable rotor 60 and the fixed core 56 and spacer 58. The magnetic attraction between the locking members 72 and the spacer 58 or the core 56 maintains the locking members 72 in the lower locked position in the grooves 70.

With continued reference to FIGS. 1-8, after the brake system, the parking brake system, the motor, the MGU or a combination thereof is turned ON or actuated, the output shaft, motor shaft 48, and rotor 56 begin rotating in an apply direction (in a counter-clockwise direction, for example). The torque output of the motor 26 is sufficient to overcome the magnetic attraction between the locking members 72 and the core 56. Accordingly, as the rotor 60 continues to rotate, the locking members 72 move from the lower position located at, near, or in the grooves 70 to the upper unlocked position where the locking members 72 are located at, near, or against the upper portion 74 of the detents 62 (e.g., tip towards the 12 o'clock position in FIG. 8) so that the locking members 74 are no longer in communication with or contact the fixed, non-rotatable core 56 and spacer 58. Continued rotation of the rotor 56 causes the locking members 72 to remain in the upper unlocked position due to centrifugal force acting on the locking members 72 being stronger than the magnetic force attracting the locking members 72 to the core 56. The motor output 44 rotates with the motor shaft 48 and rotor 56, which causes the rotary to linear stage mechanism 36 to move the corresponding brake piston 32 or expander mechanism 54, which causes the corresponding brake pad or brake shoe to move against the respective brake rotor or brake drum to create the clamp force, as was discussed above.

With continued reference to FIGS. 1-8, after a desired clamp force is generated, the motor 26 or MGU ceases to rotate, and, accordingly, the motor shaft 48 and rotor 60 also cease rotating, which causes the torque locking mechanism 28 to lock or engage. That is, when the motor shaft 48 and rotor 60 cease rotating, the centrifugal force holding the locking members 72 in the upward position at or near the upper surface 74 is reduced or eliminated, and the magnetic attraction between the locking members 72 and the core 56 functions to pull or drop the locking members 72 into the lower position in the grooves 70 as partially illustrated in FIG. 8. The rotor 60 and the motor shaft 48 are thus prevented from rotating or back driving due to the locking members 72 being located or wedged between the moveable rotor 60 and the fixed core 56 and spacer 58 and the magnetic attraction maintaining the locking members 72 in the grooves 70 of the fixed spacer 58 and core 56. The torque locking mechanism 28 is then locked or engaged.

If a re-clamp is required, for example to generate additional clamp force, the motor 26 or MGU can be turned ON, which causes the output shaft 44, motor shaft 48, and rotor 56 to rotate in an apply direction (e.g., counter-clockwise, according to FIG. 8, for example). The incline portions 66 provide a reduced load for the motor 26 so that the locking members 72 can move up the incline portions 66 and then drop or fall into the next groove 70. This may continue until the desired clamp load is developed. The edge 68 provides an increased load for the motor 26 to restrict or prevent rotation or back drive in a release direction (e.g., clockwise) when the motor 26 or MGU is turned OFF.

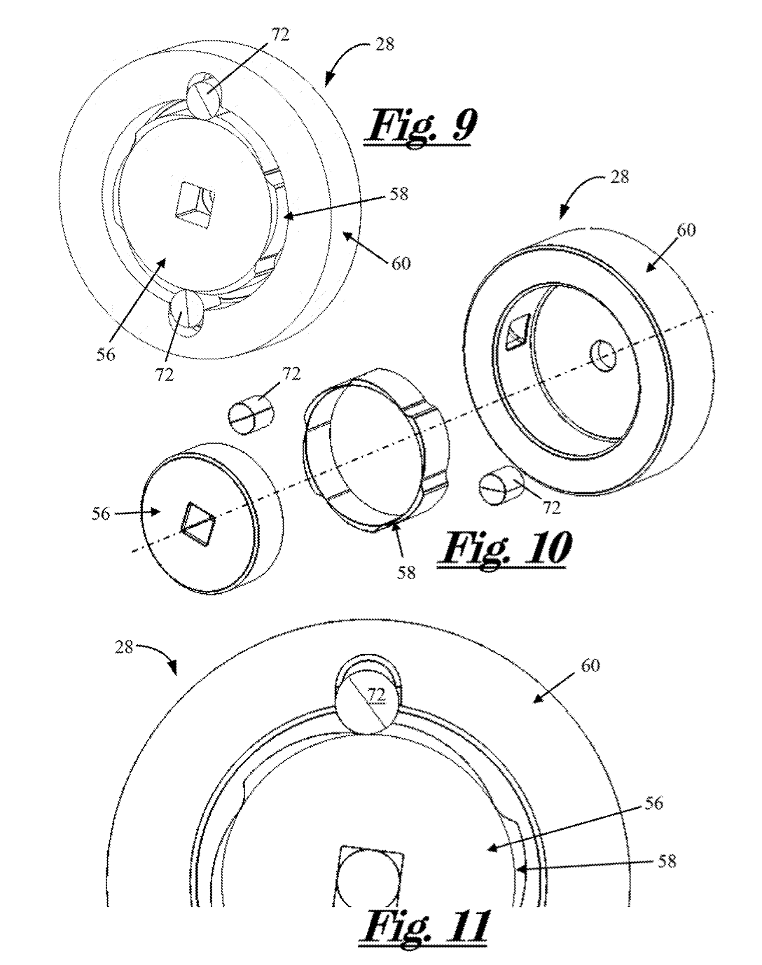

FIGS. 9-11 illustrate another torque locking mechanism 28. The torque locking mechanism 28 comprises a non-rotating or fixed core 56; a plurality of locking members 72; a non-rotating or fixed spacer 58; and a rotor 60 that is fixed to the motor shaft 48 of the motor 26 (FIG. 4) and rotates therewith. The spacer 58 is fixed to the core 56.

The torque locking mechanism 28 of FIGS. 9-11 may be substantially similar to torque locking mechanism 28 illustrated in FIGS. 5-8 and described above, except the locking members 72 of FIGS. 9-11 are generally cylindrically-shaped, while the locking members 72 illustrated in FIGS. 5-8 are generally spherically-shaped or round.

In the interest of brevity, operation of the brake system, the parking brake system, or both of FIGS. 9-11 will not be described since operation of the systems of FIGS. 1-8 described above is substantially the same to that of FIGS. 9-11.

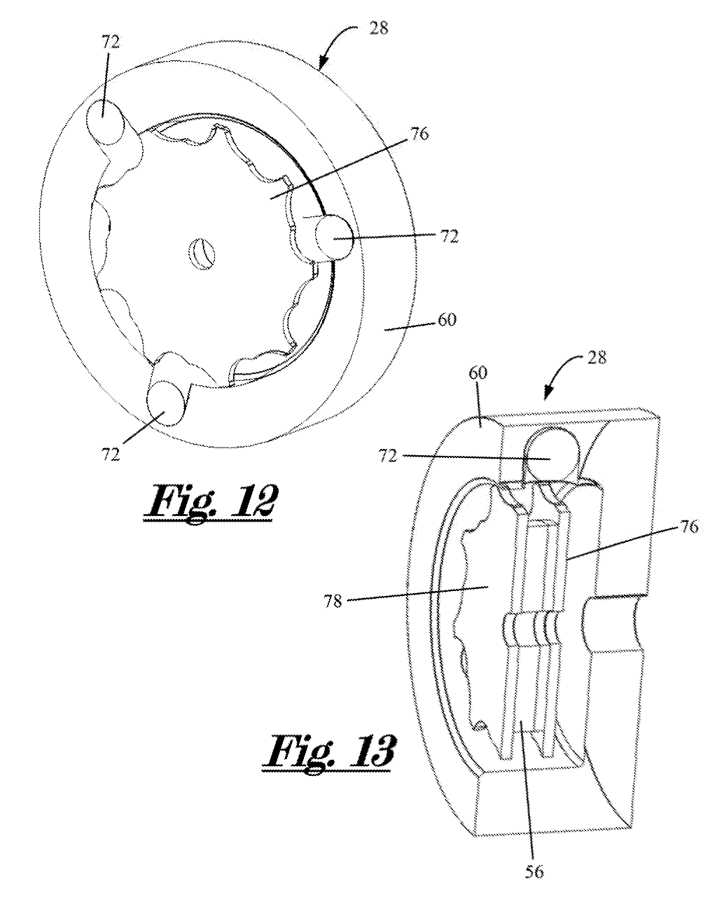

FIGS. 12-17 illustrate a torque locking mechanism 28. The torque locking mechanism 28 comprises a fixed or stationary core 56 that does not rotate; pair of fixed or stationary plates 76, 78 that do not rotate and sandwich the core 56; and a rotor 60 that is fixed to the motor output 48 of the motor 26 (FIG. 4) and rotates therewith when the motor 26 or MGU are ON or running.

Locking members 72 are received in detents 62 disposed around an inner diameter 63 of the rotor 60. The core 56 comprises a first core plate 55 and a second core plate 57. The locking members 72 are magnetically attracted to the core plates 55, 57. That is, either the core plates 55, 57 are magnets or permanent magnets and the locking members 72 are made of a material magnetically attracted to the core plates 55, 57, or the locking members 72 are magnets or permanent magnets, and the core plates 55, 57 are made of a material magnetically attracted to the locking members 72.

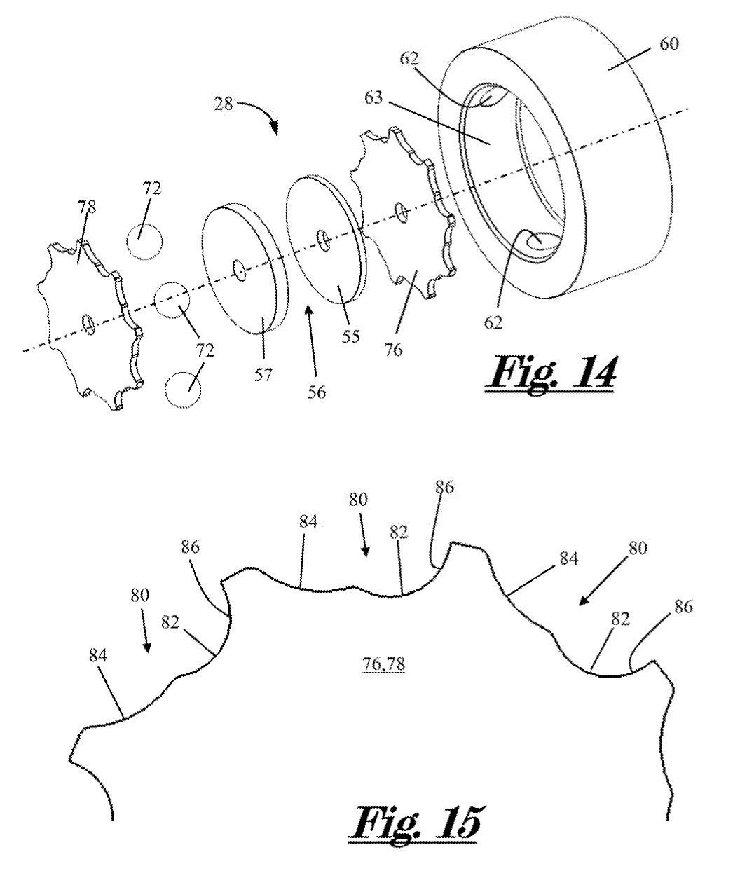

Referring specifically to FIG. 15, the plates 76, 78 have substantially the same geometry. Each of the plates comprises a plurality of ramps 80 disposed around a circumference thereof. Each ramp 80 comprises a first groove 82, a second groove 84, and an edge 86.

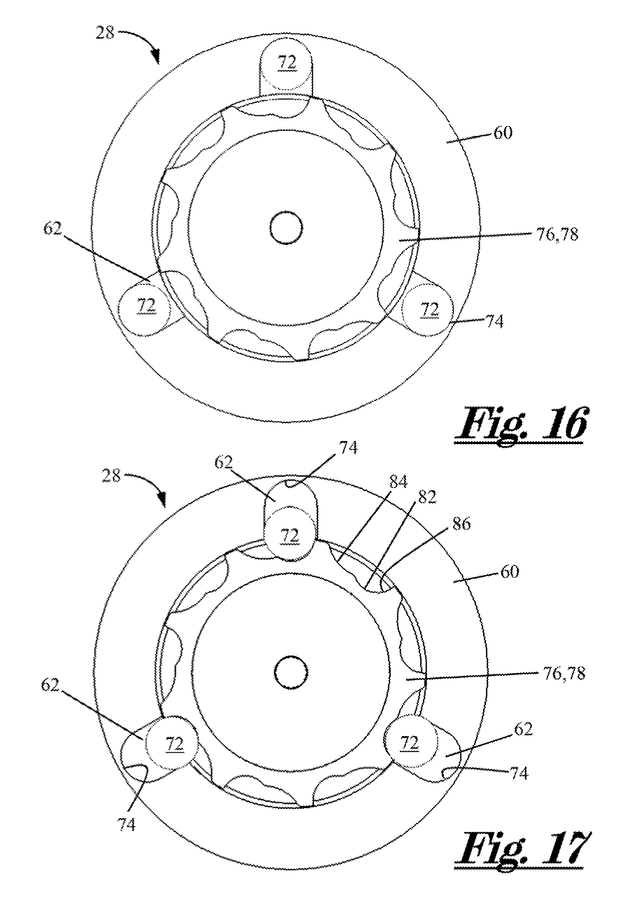

FIG. 16 illustrates the torque locking mechanism 28 in the unlocked or disengaged position, and FIG. 17 illustrates the torque locking mechanism 28 in the locked or engaged position.

Referring to FIGS. 1-4 and 12-17, before the brake or the parking brake is actuated (i.e., during a free running condition of the vehicle; when the motor 26 or MGU is OFF; and/or when electrical power is not being supplied to the motor 26 or MGU), the torque locking mechanism 28 is in the locked or engaged position (FIG. 17). This means the magnetic attraction between the locking members 72 and the core 56 or core plates 55, 57 pulls or draws the locking members 72 into one of the grooves 82, 84 of plates 76, 78. The rotor 60 and the motor shaft 48 are prevented from rotating or back driving due to the locking members 72 being located or wedged in between the moveable rotor 60 and the fixed plates 76, 78, and the magnetic attraction maintaining the locking members 72 in the grooves 82, 84.

After the brake or the parking brake is actuated, the motor output 40, the motor shaft 48, and rotor 56 begin rotating in an apply direction due to the torque output of the motor 26 being sufficient to overcome the magnetic attraction between the locking members 72 and the core plates 55, 57 so that the locking members 72 move out of the grooves 82, 84. As the rotor 60 continues to rotate, centrifugal forces overcomes the magnetic attraction between the locking members 72 and core plates 55, 57, which causes the locking members 72 to move into or against an outer or upper portion 74 of the detents 62 so that the locking members 74 are no longer in communication with the fixed plates 76, 78.

After the locking members 74 are near or against the outer or upper portion 74 of the detents, the torque locking mechanism 28 is unlocked or disengaged. As the motor shaft 48, and rotor 56 rotate in the apply direction, the rotary to linear stage mechanism 36 moves the corresponding brake piston 32 or expander mechanism 54, which causes the corresponding brake pad or brake shoe to move against the brake rotor or brake drum to create the clamp force.

After a desired clamp force is generated, the motor 26 or MGU ceases to rotate such that the motor shaft 48 and rotor 60 also cease rotating, which causes the torque locking mechanism 28 to lock or engage. That is, when the motor shaft 48 and rotor 60 cease rotating, the magnetic attraction between the locking members 72 and the core plates 55, 57 pulls the locking members 72 into the grooves 82 or 84. The rotor 60 and the motor shaft 48 are prevented from rotating or back driving due to the locking members 72 being located between the moveable rotor 60 and the fixed plates 76, 78 and the magnetic attraction maintaining the locking members 72 in the grooves 82 or 84 of the plates 76, 78.

If a re-clamp is required, the motor 26 is turned ON, which causes the output shaft 44, motor shaft 48, and rotor 56 to rotate in an apply direction (e.g., counter clockwise for example). An incline portion between grooves 82 and 84 provides a reduced load for the motor 26 as the locking members 72 move from groove 82 to 84, or from groove 84 to groove 82 of an adjacent ramp 80 until the desired clamp load is developed. The edge 86 provides an increased load for the motor 26 to restrict or prevent rotation or back drive in a release direction (e.g., clockwise) when the motor 26 is turned OFF.

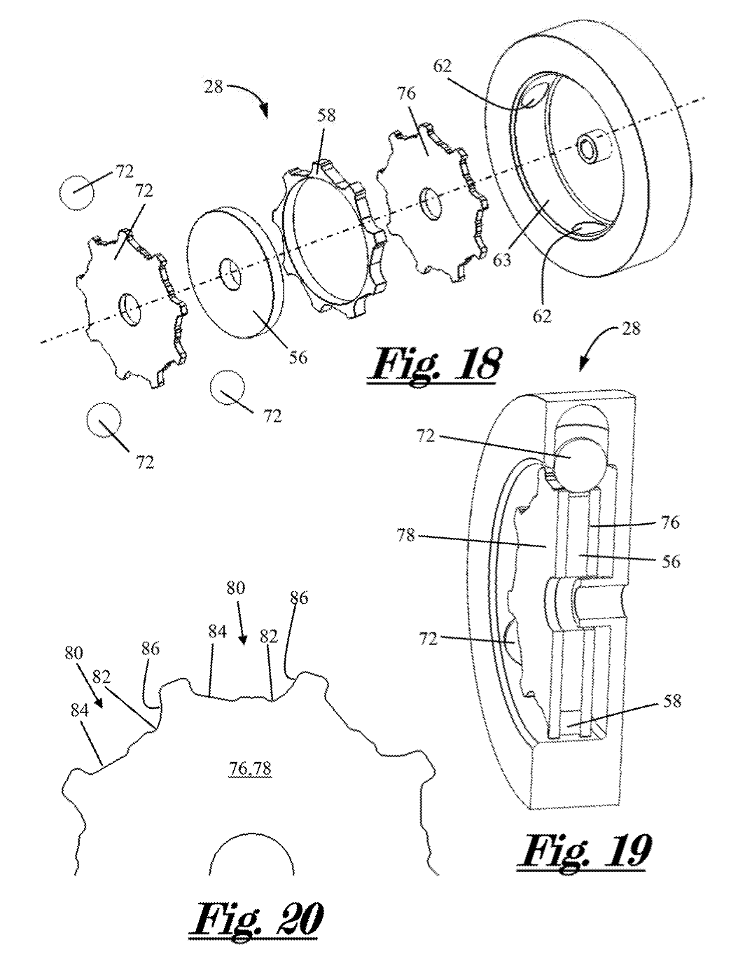

FIGS. 18 and 19 illustrate a torque locking mechanism 28, and FIG. 20 illustrates a portion of the plates 76, 78 of the torque locking mechanism of FIGS. 18 and 19. The torque locking mechanism 28 comprises a stationary or fixed core 56; a spacer 58 surrounding the core 56; a pair of fixed or stationary plates 76, 78 that sandwich the core 56 and the spacer 58 and also do not rotate; and a rotor 60 that is fixed to the motor output 48 of the motor 26 (FIG. 4) and rotates therewith.

Locking members 72 are received in detents 62 disposed around an inner diameter 63 of the rotor 60. The locking members 72 are magnetically attracted to the core 56. That is, either the core 56 is a magnet and the locking members 72 are made of a material magnetically attracted to the core 56, or the locking members 72 are magnets or permanent magnets, and the core 56 is made of a material magnetically attracted to the locking members 72.

Referring specifically to FIG. 20, the plates 76, 78 have substantially the same geometry. Each of the plates comprises a plurality of ramps 80 disposed around a circumference thereof. Each ramp 80 comprises a first groove 82, a second groove 84, and an edge 86. The ramps 80 are substantially similar to the ramps illustrated in FIG. 15, except the ramps of FIG. 20 have a more gradual transition between he grooves 82, 84 than those illustrated in FIG. 15, which may advantageously allow or provide for the locking members 72 to move more gradually between the grooves 82, 84. This may advantageously prevent a motor stall condition, which may be realized if the motor is unable to produce enough torque to rotate the rotor 60 for the locking members 72 to move from groove 82 to 84 in FIG. 15.

In the interest of brevity, operation of the torque locking mechanism, the brake system, the parking brake system, or a combination thereof of FIGS. 18-20 will not be described since operation of the system of FIGS. 12-17 described above is substantially the same to that of FIGS. 18-20.

The explanations and illustrations presented herein are intended to acquaint others skilled in the art with the invention, its principles, and its practical application. The above description is intended to be illustrative and not restrictive. Those skilled in the art may adapt and apply the invention in its numerous forms, as may be best suited to the requirements of a particular use.

Accordingly, the specific embodiments of the present invention as set forth are not intended as being exhaustive or limiting of the teachings. The scope of the teachings should, therefore, be determined not with reference to this description, but should instead be determined with reference to the appended claims, along with the full scope of equivalents to which such claims are entitled. The omission in the following claims of any aspect of subject matter that is disclosed herein is not a disclaimer of such subject matter, nor should it be regarded that the inventors did not consider such subject matter to be part of the disclosed inventive subject matter.

Plural elements or steps can be provided by a single integrated element or step. Alternatively, a single element or step might be divided into separate plural elements or steps.

The disclosure of “a” or “one” to describe an element or step is not intended to foreclose additional elements or steps.

By use of the term “may” herein, it is intended that any described attributes that “may” be included are optional.

While the terms first, second, third, etc., may be used herein to describe various elements, components, regions, layers and/or sections, these elements, components, regions, layers and/or sections should not be limited by these terms. These terms may be used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The disclosures of all articles and references, including patent applications and publications, are incorporated by reference for all purposes. Other combinations are also possible as will be gleaned from the following claims, which are also hereby incorporated by reference into this written description.

1) A brake system comprising:
a) a motor;
b) a rotary to linear stage mechanism in communication with the motor; and
c) a torque locking mechanism in communication with the motor, the torque locking mechanism comprising:
i. a rotor;
ii. a core; and
iii. a plurality of locking members;
wherein during a brake apply, the motor is adapted to rotate the rotor and move the rotary to linear stage mechanism so that at least one brake pad or brake shoe is moved against a surface to generate a clamp force, and
wherein after the clamp force is generated and the motor ceases to rotate the rotor, a magnetic attraction between the core and the locking members is adapted to move the locking members towards the core so that the generated clamp force is maintained and prevented from back driving.

2) The brake system of claim 1, wherein the rotor includes a plurality of detents, and one of the locking members is located in one of the detents, and
wherein during the brake apply, a centrifugal force generated by rotation of the rotor overcomes the magnetic attraction between the core and the locking members so that the locking members move away from the core and move to a n upper portion of the detents.

3) The brake system of claim 1, wherein the torque locking mechanism includes a spacer that is fixed to the core, the spacer includes a plurality of grooves that are engaged by the locking members when the locking members move towards the core to maintain the generated clamp force.

4) The brake system of claim 3, wherein the spacer includes a plurality of ramps, each of the ramps include an incline portion and a groove,
wherein during a re-clamp, the locking members are adapted to be moved up the incline portion into an adjacent groove as the rotor is rotated by the motor.

5) The brake system of claim 1, wherein the torque locking member comprises a pair of plates that sandwich the core, each of the plates include grooves that are engaged by the locking members when the locking members move towards the core to maintain the generated clamp force.

6) The brake system of claim 5, wherein each of the plates include a plurality of ramps, each of the ramps comprise a first groove and a second groove a at an incline relative to the first groove, and
wherein during a re-clamp, the locking members are adapted to be moved up the ramp from the first groove to the second groove, or from the second groove to an adjacent first groove.

7) The brake system of claim 3, wherein the core is a permanent magnet, and the locking members are magnetically attracted to the core.

8) The brake system of claim 3, wherein the locking members are permanent magnets.

9) The brake system of claim 1, wherein the locking members are cylindrically shaped.

10) The brake system of claim 1, wherein the locking members are spherically shaped.

11) A system comprising:
a) a motor comprising a motor output;
b) a rotary to linear stage mechanism in communication with the motor output; and
c) a torque locking mechanism in communication with the motor, the torque locking mechanism comprising:
i. a rotor fixed to the motor output, the rotor comprises a plurality of detents;
ii. a core that is fixed and restricted from rotating relative to the rotor;
iii. a plurality of ramps surrounding the core; and
iv. a plurality of locking members;
wherein during a first condition, the motor output is adapted to rotate the rotor and move the rotary to linear stage mechanism to generate a clamp force,
wherein after the clamp force is generated and the motor output ceases to rotate the rotor, the core and the locking members are magnetically attracted and the looking members move towards the core until the locking members engage a groove defined between adjacent ramps so that the generated clamp force is maintained and the rotary to linear state mechanism is prevented from back driving, and
wherein during a second condition, a centrifugal force generated by the motor and the rotating rotor overcomes the magnetic attraction causing the locking members to move to an outer portion of the detents and out of engagement with the grooves.

12) The system of claim 11, wherein the grooves are located on a spacer that surrounds the core.

13) The system of claim 1, wherein the grooves are located on a pair of plates that sandwich the core.

14) The system of claim 11, wherein the core is a magnet, and the locking members are magnetically attracted to the core.

15) The system of claim 11, wherein the locking members are magnets.

16) A system comprising:
a) a motor comprising a motor output;
b) a torque locking mechanism in communication with the motor output, the torque locking mechanism comprising:
i. a rotor fixed to the motor output, the rotor comprises a plurality of detents;
ii. a core that is fixed and restricted from rotating relative to the rotor;
iii. a plurality of locking members located in the detents;
wherein the motor output is adapted to generate torque, and after the torque is generated, the torque locking mechanism is adapted to maintain or prevent back driving of the motor output.

17) The system of claim 16, wherein a magnetic attraction between the locking members the core moves the locking members into a locked position against the core maintain or prevent back driving of the motor output after the torque is generated.

18) The system of claim 17, wherein a centrifugal force generated by rotation of the motor output overcomes the magnetic attraction between the core and the locking members so that the locking members move into an upper portion of the detents and away from the core.

19) The system of claim 18, wherein an outer surface of the core comprises a plurality of ramps, each of the ramps include an incline portion and a groove,
wherein the locking members are moved up the incline portion into an adjacent groove as the rotor is rotated by the motor when the motor generates additional torque but the magnetic force is greater than the centrifugal force generated by rotation of the motor output.

20) The system of claim 17, wherein the core is a magnet, and the locking members are magnetically attracted to the core.
